(19) United States
(12) Patent Application Publication
(10) Pub. No.: US 2018/0285944 A1
(43) Pub. Date: Oct. 4, 2018

(54) Methods and Systems for Use in Providing Spend Profiles for Reviewers, in Response to Requests for Validation of Reviews Submitted by the Reviewers

(71) Applicant: MASTERCARD INTERNATIONAL INCORPORATED, Purchase, NY (US)

(72) Inventors: Lisa Groarke, Dublin (IE); Peter Groarke, Dublin (IE); Ahmed Hosny, Dublin (IE)

(21) Appl. No.: 15/473,890

(22) Filed: Mar. 30, 2017

(51) Int. Cl. G06Q 30/02

(52) U.S. Cl. CPC G06Q 30/0282; G06Q 30/0201

(57) ABSTRACT

Systems and methods herein are suitable for use in providing spend profiles for reviewers in response to requests for validation of reviews submitted by the reviewers. One exemplary method includes receiving a request to validate a review from a requestor. The request includes a token, and the review is compiled by a consumer and relates to at least one of a product and a merchant. The method also includes identifying a payment account based on the token, where the payment account is associated with the consumer, and compiling a spend profile for the consumer based on a transaction history associated with the identified payment account. The method then further includes transmitting the spend profile to the requestor, in response to the request, thereby permitting said requestor to associate the spend profile with the review and to evaluate the review based on the spend profile.

### FIELD

The present disclosure generally relates to methods and systems for use in providing spend profiles for reviewers in response to requests for validation of reviews submitted by the reviewers, and in particular, to methods and systems for use in compiling the spend profiles for the reviewers, which are then provided to merchants and/or forums in response to requests related to reviews submitted by the reviewers, whereby the merchants and/or forums are able to validate and/or designate the reviews based on the spend profiles.

### BACKGROUND

This section provides background information related to the present disclosure which is not necessarily prior art.

Consumers are known to purchase products (e.g., goods and services, etc.) from merchants. Transactions to purchase the products are commonly funded by payment accounts. Prior to, or after, the purchase of such products, consumers or others are known to provide reviews of the products and/or of the merchants at which the products were purchased. The reviews may include, for example, the consumers' descriptions and/or ratings of the products/merchants (e.g., based on a 1-5 star system, etc.). The reviews may also include comments about good and/or poor aspects of the products/merchants. Further, various merchants, and others (depending on to whom the reviews are submitted) publish the reviews to forums (e.g., to websites, etc.), to provide insight offered by the reviews to potential consumers. In connection therewith, it is known for the reviews, and/or the ratings included in the reviews, to aid the potential consumers in deciding whether to purchase the products from the merchants, or not.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure operable to provide spend profiles for one or more reviewers submitting reviews, in response to requests to validate the reviews;

FIG. 2 is a block diagram of an exemplary computing device that may be used in the system of FIG. 1; and

FIG. 3 is an exemplary method, which may be used with the system of FIG. 1, for providing spend profiles for one or more reviewers submitting reviews, in response to one or more requests to validate the reviews.

Corresponding reference numerals indicate corresponding parts throughout the several views of the drawings.

### DETAILED DESCRIPTION

Example embodiments will now be described more fully with reference to the accompanying drawings.

Consumers often purchase products (e.g., goods and services, etc.) through use of payment accounts. Separately, individuals, whether consumers or others, provide reviews of products and/or of merchants at which the products are purchased, whereupon the reviews may become available to potential consumers for the products and/or to the merchants, etc. The reviews can affect, depending on the content of the reviews, the consumers' purchasing decisions as to the products and/or merchants, positively or negatively. What's more, credence given to the reviews, by the potential consumers, may be altered by the reviewers' experience with the products and/or merchants, as indicated in the reviews, and/or by the reviewer's experience with like products and/or like merchants (e.g., within a common category, etc.). Uniquely, the systems and methods herein permit reviews to be validated to purchases of products at merchants and/or to be associated with spend profiles of the consumers offering the reviews. In particular, in connection with an individual offering a review for a product purchased from a merchant, a validation engine is provided to initially, in some embodiments, validate whether the consumer has actually purchased the product and/or interacted with the merchant that is the subject of the review. Additionally, or alternatively, in several embodiments, the validation engine compiles a spend profile for the consumer offering the review, whereby the merchant identified in the review and/or a potential consumer viewing the review may associate proper weighting and/or credibility to the review, based on the profile of the individual offering the review. In this manner, the review may then be published, or not, by the merchant, or others, based on the validation along with information about the reviewing individual, to thereby provide an efficient manner to enable other consumers to have confidence (or skepticism) regarding the published review.

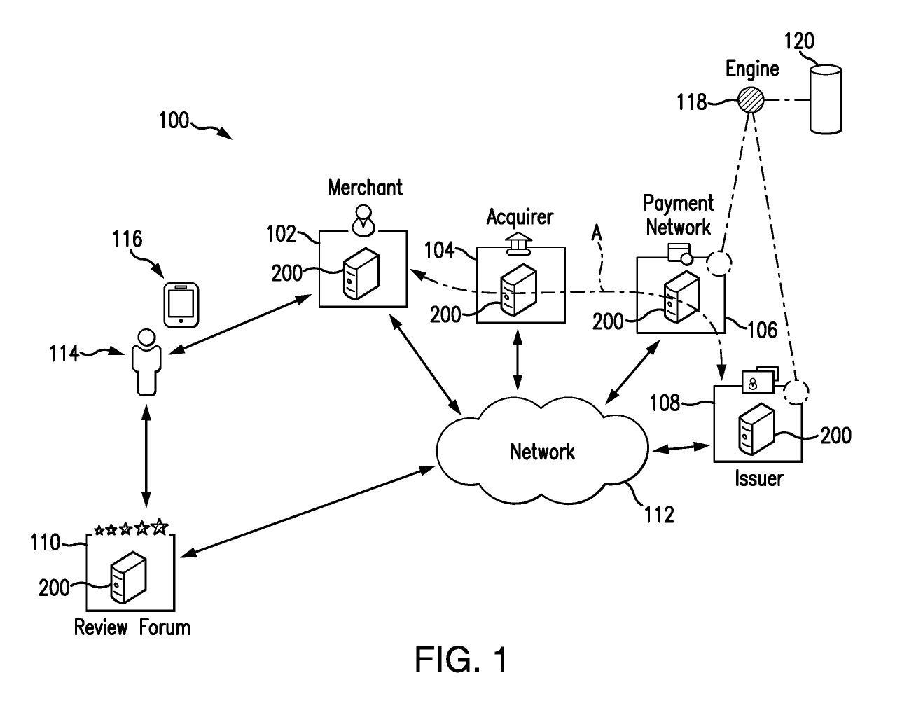

FIG. 1 illustrates an exemplary system 100, in which the one or more aspects of the present disclosure may be implemented. Although the system 100 is presented in one arrangement, other embodiments may include systems arranged otherwise depending, for example, on the manner in which reviews are published to potential consumers, when/how reviews are submitted and/or validated, etc.

The illustrated system 100 generally includes a merchant 102, an acquirer 104 associated with the merchant 102, a payment network 106, an issuer 108 configured to issue payment accounts to consumers, and a review forum 110, each of which is coupled to (and is in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 112 may include multiple different networks, such as a private payment transaction network made accessible by the payment network 106 to the acquirer 104 and the issuer 108 and, separately, the public Internet, which is accessible as desired to the merchant 102, the acquirer 104, the issuer 108, and the review forum 110, etc.

In the exemplary embodiment, the merchant 102 is configured to offer for sale and to sell products to consumers including, for example, consumer 114. The merchant 102 may be disposed and/or accessible at one or more physical locations, such as, for example, at one or more brick-and-mortar locations, and/or at one or more virtual locations, such as, for example, via one or more network-based applications (e.g., a website, etc.). Regardless of the location(s), consumers (e.g., the consumer 114, etc.) are able to interact with the merchant 102 to purchase products.

The consumer 114, in this embodiment, is associated with a payment account, which is issued by the issuer 108. The consumer 114 is then able to use the payment account to fund transactions with merchants, including the merchant 102.

In one example transaction, when the consumer 114 identifies a product to purchase, the consumer 114 presents a payment device associated with the consumer's payment account to the merchant 102 to initiate the transaction for the product. In connection therewith, the merchant 102 receives and/or retrieves credentials for the consumer's payment account from the payment device, for example, via a point-of-sale (POS) terminal, and then communicates an authorization request for the transaction to the acquirer 104 through the network 112 (along path A in FIG. 1, as is conventional). In turn, the acquirer 104 communicates the authorization request with the issuer 108, through the payment network 106 (again via the network 112), for authorization of the transaction (e.g., to determine if the user's payment account is in good standing and if there is/are sufficient credit/funds to complete the transaction, etc.). If the issuer 108 accepts the transaction, an authorization reply is provided back to the merchant 102 (again, generally along path A) approving the transaction, and the merchant 102 is then able to proceed in the transaction. The transaction is later cleared and settled by and between the merchant 102 and the acquirer 104 and by and between the acquirer 104, the payment network 106, and the issuer 108 (in accordance with appropriate settlement arrangements, etc.). Conversely, if the issuer 108 declines the transaction, an authorization reply is provided back to the merchant 102 declining the transaction, and the merchant 102 is able to terminate the transaction with the consumer 114, or request an alternate form of funding.

Transaction data is generated, collected, and stored as part of the above interactions among the merchant 102, the acquirer 104, the payment network 106, the issuer 108, etc. The transaction data, in this exemplary embodiment, is stored at least by the payment network 106 (e.g., in a data structure associated with the payment network 106 (or in association with a validation engine 118, as described below), etc.). Additionally, or alternatively, the acquirer 104 and/or the issuer 108 may store the transaction data so as to be accessible as described herein. With that said, transaction data may include, for example, payment account numbers (e.g., primary account numbers (PANs), etc.), transaction amounts, merchant IDs, merchant category codes (MCCs), region codes for merchants involved in transactions and/or POS terminals associated with the merchants, merchant names, dates/times, products purchased and related descriptions or identifiers thereof, etc. It should be appreciated that more or less information related to transactions, as part of either authentication of consumers, authorization and/or clearing and/or settling of the transactions, etc. may be included in transaction data and stored within the system 100, at the merchant 102, the acquirer 104, the payment network 106, and/or the issuer 108. Further, data unrelated to particular payment accounts may be collected by a variety of techniques, and similarly stored within the system 100.

In various exemplary embodiments, consumers involved in the different transactions/interactions herein are prompted to agree to legal terms associated with their payment accounts, for example, during enrollment in their accounts, upon installation of related applications to their communication devices, etc. In so doing, the consumers may voluntarily agree, for example, to allow certain entities to use data collected during enrollment and/or collected in connection with processing the transactions, subsequently, at least for one or more of the different purposes described herein.

With continued reference to FIG. 1, in this exemplary embodiment, the merchant 102 is associated with, provides, and/or includes a review forum, which may be integrated with one or more network-based application(s), for example, at which current consumers are able submit reviews of the products purchased at the merchant 102 and/or reviews about interactions and/or experiences with the merchant 102. The reviews may then be viewed by other consumers or potential consumers, to, for example, aid the consumers in making purchasing decisions. Similarly, in this way, the review forum 110 is configured to solicit and to accept reviews for products and/or merchants (e.g., for the merchant 102, etc.), from consumers or other persons, and further to publish the reviews for the consumers (e.g., on behalf of the consumers, etc.), thereby enabling other consumers (e.g., potential consumers for the given products and/or the merchant 102, etc.) to view the reviews. The review forum 110 may include, without limitation, one or more social network-based application (e.g., Facebook™, Twitter™, Yelp™, Instagram™, Pinterest™, Reddit™, Angie's List™, TripAdvisor™, etc.), or other forums suitable to be used as described herein.

Also in the illustrated system 100, the consumer 114 is associated with a communication device 116. The communication device 116 may include, for example, a smartphone, a laptop, a tablet, etc. Often, though, the communication device 116 will include a portable communication device, so that the communication device 116 is located with and/or carried with the consumer 114, for use as described herein.

While only one consumer 114 is shown in the system 100 in FIG. 1, it should be appreciated that more than one consumer (and, often, tens, hundreds, thousands, etc. of consumers) may be included in the system 100 and/or in other system embodiments. Similarly, while only one merchant 102, one acquirer 104, one payment network 106, one issuer 108, and one review forum 110 are illustrated, it should be appreciated that any number of these entities (and their associated components) may be included in the system 100, or may be included as a part of systems in other embodiments, consistent with the present disclosure.

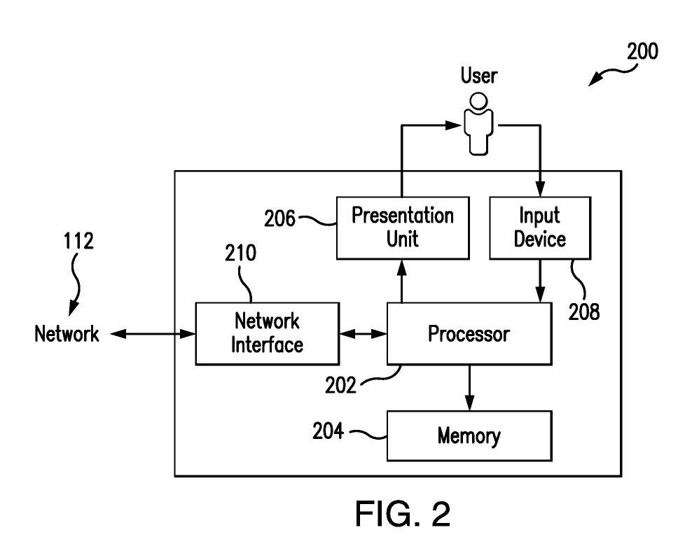

FIG. 2 illustrates an exemplary computing device 200 that can be used in the system 100. The computing device 200 may include, for example, one or more servers, workstations, personal computers, laptops, tablets, smartphones, PDAs, terminals, etc. In addition, the computing device 200 may include a single computing device, or it may include multiple computing devices located in close proximity or distributed over a geographic region, so long as the computing devices are specifically configured to function as described herein. In the system 100 of FIG. 1, each of the merchant 102, the acquirer 104, the payment network 106, the issuer 108, and the review forum 110 are illustrated as including, or being implemented in, a computing device 200 coupled to (and in communication with) the network 112. In addition, the communication device 116 is also consistent with the computing device 200, and may be coupled to (and in communication with) the network 112. That said, however, the system 100, or parts thereof, should not be understood to be limited to the computing device 200, as other computing device may be employed in other system embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, transaction requests, product reviews, merchant reviews, spend profiles (e.g., ratings, metrics, etc.), and/or other types of data (and/or data structures) as needed and/or suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the operations or processes described herein.

In the exemplary embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., reviews, spend profiles, tags or indicators, etc.), either visually or audibly, to a user of the computing device 200, for example, the consumer 114 in the system 100 (e.g., at the communication device 116, etc.), a user associated with the merchant 102, a user associated with the review forum 110, etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, entries of reviews, requests for validation and/or spend profiles, etc., or inputs from other computing devices. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network 112. Further, in some exemplary embodiments, the computing device 200 includes the processor 202 and one or more network interfaces incorporated into or with the processor 202.

Referring again to FIG. 1, the system 100 includes validation engine 118, which is configured, by executable instructions, to operate as described herein. The validation engine 118 is shown in FIG. 1 as a standalone part of the system 100, and is generally consistent with computing device 200. Alternatively, and as indicated by the dotted lines in FIG. 1, the validation engine 118 may be incorporated, in whole or in part, into the issuer 108 and/or the payment network 106. In addition, the validation engine 118 is coupled to a data structure 120, which may be standalone from the validation engine 118 or, as indicated by the dotted line, may be incorporated in whole, or in part, with the validation engine 118. The data structure 120 includes, at the least, transaction data for the payment account associated with the consumer 114 (e.g., as received from and/or provided by the payment network 106 and/or the issuer 108, etc.) and, potentially, transaction data for payment accounts associated with other consumers.

In this exemplary embodiment, the validation engine 118 is configured to register the consumer 114 (e.g., the consumer's payment account, etc.) to one or more services (e.g., loyalty services, reward services, fraud protection services, etc.) associated with the validation engine 118, the payment network 106, and/or the issuer 108, for example. As part of registration, the consumer 114 provides his/her name, a payment account number for his/her payment account, contact information, and, generally, other information relevant or irrelevant to the service(s) for which the consumer 114 is registering. In at least one embodiment, the consumer 114 registers for a review validation service (as part of the one or more services), as described generally herein. Regardless of the type of service(s) to which the consumer 114 is registered, though, the validation engine 118 is configured, upon such registration, to issue a token to the consumer 114, which is unique to the consumer 114, as compared to other consumers, if any, registered to the validation engine 118. The token, then, is provided in a form, whereby when the consumer 114 is registered for the review validation service (and receives the token), the consumer 114 may present the token to the merchant 102 and/or review forum 110, as contemplated herein.

Apart from registration, the consumer 114 may seek to author one or more reviews for a product and/or merchant (e.g., the merchant 102, etc.). To do so, the consumer 114 will often interact with the merchant 102 and/or the review forum 110 (e.g., via one or more network-based interfaces, etc.). Once the review is written and/or compiled by the consumer 114 and submitted, the review may be published by the merchant 102 and/or the review forum 110 for others to view. In the illustrated embodiment, to submit the review, the merchant 102 and/or the review forum 110 is configured to require, or to request, that a token (issued to the consumer 114 as described above) be submitted with the review. Before, or after, or even as part of publishing the review, the merchant 102 and/or the review forum 110 (broadly, a requestor) is configured to then submit a request for validation of the consumer 114 (including the token) to the validation engine 118.

The validation engine 118, in turn, is configured to receive the request and to identify the payment account of the consumer 114 based on the token, from the data structure 120. Once the payment account is identified, in one or more embodiments, the validation engine 118 may be configured to validate the particular transaction for which the review was submitted. For example, simply, the validation engine 118 may be configured to validate the transaction by merely identifying that the merchant 102 is in the transaction history for the consumer's payment account in the data structure 120. It should be understood that additional details of the particular transaction may be provided with the request, whereby the validation may include further searching and/or matching within the transaction history for the consumer's payment account, in the data structure 120 (e.g., to identify the particular transaction with the merchant 102, etc.). Regardless, once the transaction is validated (which is not required in all embodiments), the validation engine 118 is configured to compile a spend profile for the consumer's payment account, and more generally, for the consumer 114. Compilation of the spend profile by the validation engine 118 may be limited, for example, to the category of the merchant 102 and/or a category of the purchased product, which is the subject of the review. Or, compilation of the spend profile may be based on multiple different such categories, or in some embodiments, on the consumer's entire transaction history (potentially limited by date, etc.). The validation engine 118 is configured to then transmit the spend profile to the merchant 102 and/or the review forum 110, or more broadly, to the requestor of the validation, whereby the merchant 102 and/or the review forum 110 is able to use the spend profile to further inform potential consumers seeing the review in one way or another (or, for example, to determine whether to publish or not publish the review, etc.). In one example, a review may be appended with a “frequent diner” tag (or indicator) or some other tag (or indicator) or rating (e.g., a rating for the consumer 114 based on a scale of one to five taking into account one or more metrics in the spend profile, etc.), by the merchant 102 and/or the review forum 110, in response to the content of the spend profile, as appropriate (e.g., where the consumer 114 is submitting a review for a restaurant merchant and where the consumer's transaction data satisfies a particular threshold relating to dining/restaurants (e.g., satisfies a spend threshold, satisfies a transaction number threshold, etc.), etc.).

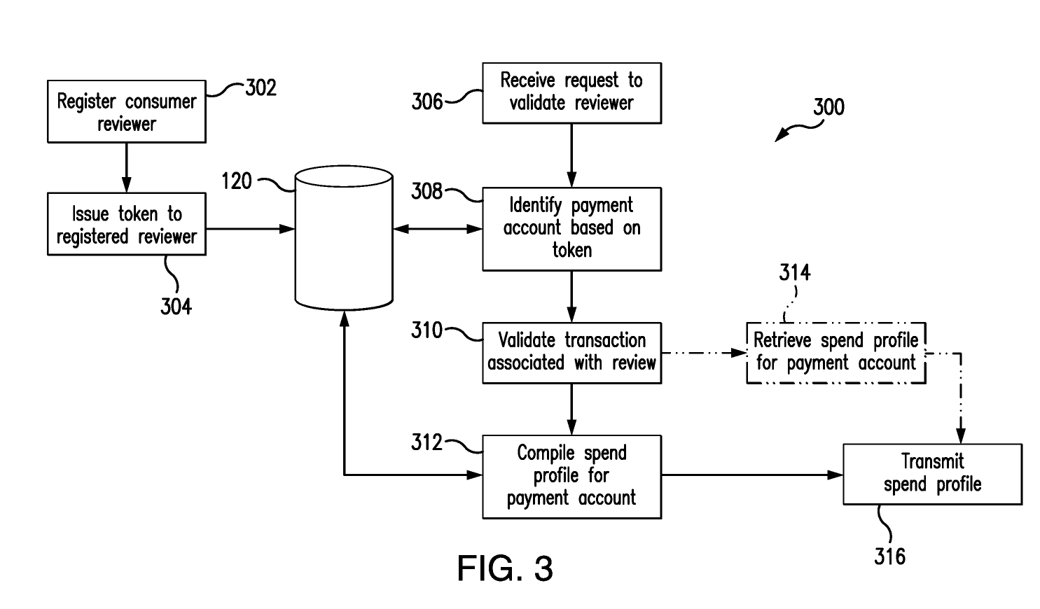

FIG. 3 illustrates exemplary method 300, for use in validating reviews and/or providing reviewer ratings for reviews. The exemplary method 300 is described as implemented in the validation engine 118 of the system 100, with it understood that the validation engine 118 is capable of performing one or more of the various operations of the method 300. Further reference is also made to the consumer 114, the review forum 110, the merchant 102, etc. of the system 100, and also to the computing device 200. However, the methods herein should not be understood to be limited to the system 100 and/or the computing device 200 Likewise, the systems and device herein should not be understood to be limited to the method 300.

At 302, the consumer 114 registers with the validation engine 118. Subsequently, or in response to the registration, the validation engine 118 issues a token, at 304, to the consumer 114 for use in validating reviews submitted by the consumer, and potentially, in association with other services offered and/or associated with the validation engine 118 (or the payment network 106 or the issuer 108, etc.). In so doing, the token is stored in the data structure 120 in association with the consumer 114 and his/her payment account. The token may include any suitable, unique identifier (with any suitable form and generated in any suitable manner) associated with the consumer so that, for example, the token generally inhibits ability of unauthorized individuals to guess or reverse engineer the token. For example, the token may include a unique numeric, alphabetic, or alphanumeric identifier; a globally unique identifier (GUID) (e.g., 5G1305F1-6D09-72B4-2V9P-1854X75R4491; etc.); a universally unique identifier (UUID); etc.).

Subsequently, after the token is issued, the consumer 114 submits a review for one or more products(s) and/or merchant(s). For purposes of illustration, in describing method 300, the consumer 114 submits a review for the merchant 102 (e.g., an “eating place” merchant, etc.), and in particular, a review for a transaction for a dining experience at the merchant 102 on May 25, to the review forum 110 (via a network-based application associated with the review forum 110 and made accessible to the consumer 114, for example, at the communication device 116 or other computing device 200, etc.). In submitting the review, the consumer 114 identifies the merchant 102 and the date of the transaction (i.e., May 25), provides a rating and/or review for the merchant 102, and further includes the token issued from the validation engine 118.

Upon receipt of the review, in this exemplary embodiment, the review forum 110 submits a request for validation of the review to the validation engine 118 (e.g., validation of the consumer 114, the transaction, combinations thereof, etc.). The request, like the review, includes the details of the transaction (i.e., identification of the merchant 102 and the May 25 date of the transaction) and also the token provided from the consumer 114.

In response, at 306, the validation engine 118 receives the request for validation (e.g., from the review forum 110, etc.). In turn, the validation engine 118 identifies, in the data structure 120, at 308, the payment account associated with the token as included in the request. To do so, the validation engine 118 searches in the data structure 120, for example, for the token. Because each token is unique to a particular payment account, the validation engine 118 is able to identify the payment account in the data structure 120 associated with the token, and also, then, to access the transaction data for the payment account (again, in the data structure 120). In this manner, the validation engine 118 generally validates the consumer 114 providing the review (e.g., validates that the consumer 114 and/or the consumer's corresponding payment account is registered for the review validation service herein, etc.). However, when the validation engine 118 is unable to identify the token in the data structure 120, the validation engine 118 may transmit a notification to the review forum 110 indicating that the consumer 114 could not be validated/proved (e.g., transmit a validation fail message, etc.), whereby the transaction forum 110 can determine whether or not to post the review.

Next in the illustrated method 300, the validation engine 118 determines, at 310, whether the transaction, which is the subject of the review, is included in the transaction data, or broadly, in the transaction history for the payment account (broadly, the validation engine 118 further validates the particular transaction). In particular, in this example, the validation engine 118 searches, in the transaction history in the data structure 120, for a transaction with the merchant 102 on May 25, for example. That is, the validation engine 118 searches to determine whether the reviewing consumer 114 was actually involved in a transaction with the named merchant 102, as indicated in the review. When the transaction is found, as in this example, the validation engine 118 is able to validate the transaction associated with the review. It should again be appreciated that various details about the transaction and/or the merchant 102 may be used to validate the transaction associated with the review. If, however, no transaction associated with the review is validated, the validation engine 118 may transmit a notification to the review forum 110 indicating that the transaction could not be validated/proved (e.g., transmit a validation fail message, etc.), whereby the transaction forum 110 can determine whether or not to post the review. Alternatively, the validation engine 118 may rely on validation of the consumer, at 308, and still continue in the method 300 but provide a warning notification with any subsequent results indicating that the particular transaction could not be validated/proved.

With that said, it should be appreciated that in one or more embodiments, the validation engine 118 may omit validation of a specific transaction associated with the review (e.g., in various embodiments, operation 310 may be omitted from method 300, etc.). In such embodiments, the validation engine 118 simply validates the consumer 114 and/or the consumer's payment account, at 308, and, when the consumer 114 and/or the consumer's payment account is validated, then proceeds in the method 300 as described next.

With continued reference to FIG. 3, the validation engine 118 next compiles, at 312, a spend profile for the consumer 114 (and the consumer's payment account) based on transaction data retrieved from the data structure 120. In this exemplary embodiment, the spend profile is compiled based on a category associated with the merchant 102, for example, and more specifically, a merchant category code (MCC) for the merchant 102. The MCC, for example, may be captured from transaction data in the data structure 120 for the transaction associated with the review, as validated at 310, or otherwise obtained for the merchant 102 (e.g., based on the merchant's name as included in the request to validate the review by the consumer 114, etc.). In the embodiment of FIG. 1, the merchant 102 is a dining merchant, whereupon the category associated with the merchant 102 is, for example, eating places. And, the MCC associated with the merchant 102 is then MCC 5812 (“Eating Places and Restaurants”). It should be appreciated that in other embodiments the spend profile for the consumer 114 may be compiled based on transaction data filtered using other features than MCC. For example, the spend profile may be compiled based on transaction data for the consumer 114 filtered using product descriptions, transaction dates, transaction locations, etc.

As an example, in compiling the spend profile for the consumer 114 based on the MCC 5812 for the merchant 102, the validation engine 118 filters the transaction history, resulting in multiple transactions (i.e., filtered transactions), which involve at least one merchant associated with the same MCC as the merchant 102, i.e., MCC 5812. In doing so, in this example, the validation engine 118 may identify sixteen transactions to eleven different merchants for which the MCC is 5812. Then, in compiling the spend profile, the validation engine 118 may include one or multiple metrics such as, for example, a number of transactions (i.e., sixteen) at merchants with MCC 5812, a total spend for the sixteen transactions in the MCC 5812, and a number of distinct merchants identified in the transactions (i.e., eleven). In addition in this example, the validation engine 118 may further determine a frequency of the transactions within a category for a defined interval (i.e., sixteen transactions in a statement month (e.g., 30 days or four weeks), or approximately 0.53 transactions per day, or four transactions per week, etc.). It should be appreciated that other metrics, and/or other metrics for other defined intervals (e.g., one week, bi-monthly, monthly, per statement, bi-annually, etc.), may be included in other compiled spend profiles for the consumer 114 and other consumers, etc. in other examples. For example, the validation engine 118 may include, in the spend profile, a metric associated with a percentage of the total transactions, spend, etc. by the consumer 114 regarding MCC 5812 relative to all other registered consumers (e.g., an indication of whether the consumer 114 is in a top 1% of restaurant spenders, in a top 10% of restaurant spenders, in a top 50% of restaurant spenders, etc.). Alternatively, or additionally, the validation engine 118 may include, in the spend profile, a metric associated with a percentage of total transactions, spend, etc. by the consumer 114 regarding multiple MCCs relative to all other registered consumers (e.g., an indication that the consumer 114 is in a top 1% of restaurant spenders, in a top 10% of pet shop spenders, and in a top 50% of alcohol spenders; etc.). Likewise, it should again be understood that the transaction history may be filtered by bases other than one or more categories (e.g., date, date range, location(s), etc.).

As another example, the validation engine 118 may compile the spend profile for the consumer 114 based on a category of the product purchased by the consumer from the merchant 102, i.e., a food product category. In so doing, the validation engine 118 may filter transactions associated with the consumer's payment account for the month based on the food product category. In so doing, the validation engine 118 may identify twelve transactions to eight different merchants, with ten of the transactions involving merchants having MCC 5812 and two of the transactions involving merchants having MCC 5411 (i.e., “Grocery Stores and Supermarkets”). Then, in compiling the spend profile in this example, the validation engine 118 may include a number of identified transactions at merchants with MCC 5812 (i.e., ten), a frequency of the transactions (i.e., ten within the last month), and indications that the consumer 114 is in a top 5% of restaurant spenders and in a top 90% of grocery store spenders (suggesting that the consumer 114 eats at restaurants more than at home, etc.).

As a further example, the merchant 102 may include a jewelry store. As such, in connection with validating a review by the consumer 114 regarding the jewelry store, the validation engine 118 may compile a spend profile for the consumer 114 based on MCC 5094 (e.g., the validation engine 118 may filter transactions associated with the consumer's payment account for the last year based on MCC 5094, etc.). In so doing, the validation engine 118 may identify eight transactions to three different merchants having MCC 5094. Then, in compiling the spend profile in this example, the validation engine 118 may include a number of identified transactions (i.e., eight) at merchants with MCC 5094, a frequency of the transactions (i.e., eight within the last year), a number of different merchants with MCC 5094 at which transactions were performed (i.e., three different merchants), and an indication that the consumer 114 is in a top 25% of jewelry store spenders relative to other registered consumers.

In addition to specific metrics, or alternately, as included in the above examples, the spend profile may include classifications of the consumer 114 and/or the payment account based on the metrics. For example, in the above example where the merchant 102 includes a restaurant with MCC 5812 and the consumer 114 performed sixteen transactions at merchants with MCC 5812 in the last statement month, three ratings of diners may be defined (e.g., by the validation engine 118, by the review forum 110, etc.), whereby consumers with five or less transactions at eating places in a month are rated as “infrequent diners,” while consumers with six to nine transactions at eating places in a month are rated as “occasional diners” and consumers with ten or more transactions at eating places in a month are rated as “frequent diners.” Further in this above example, sixteen transactions in the month (or statement cycle) rate the consumer 114 as a frequent diner. As such, the validation engine 118 may compile the spend profile to include the various metrics described above, as well as (or to merely include) the rating “frequent diner.” With that said, it should be appreciated that a spend profile may include such a rating (e.g., infrequent diner, frequent diner, etc.), which may be indicative of experience for the consumer 114, for example, or of metrics (e.g., a number of transaction to merchants of a specific MCC, a total spend, etc.), or of some combination of both.

While in the above description of the method 300 the spend profile is compiled for the consumer 114 (and his/her payment account) after a request is received from the review forum 110 (generally in real time, with the review forum 110 then generally waiting on the validation engine 118 to actually compile the spend profile and provide a response back to the review forum 110), it should be appreciated that the spend profile may be compiled for the payment account, in general (e.g., independent of any particular MCC for any particular merchant to which a potential review may be directed, etc.), or per various different category typically involved in the consumer's transactions or per various predefined categories, at one or more regular or irregular intervals, apart from a request to validate a review (e.g., as a predetermined or predefined spend profile, etc.). In connection therewith, in several of such embodiments, optionally, as indicated by the dotted lines in FIG. 3, the validation engine 118 may retrieve, at 314, the spend profile (or relevant portion thereof when based on multiple different categories) for the consumer 114, for example, from the data structure 120, etc. (as related to a subsequent request). For example, the validation engine 118 may maintain a predefined spend profile for the consumer 114 (and his/her payment account) based on his/her transaction data (and for other consumers similarly registered for the for the review validation service herein) (e.g., a payment card profile keyed on card-number off line, etc.). In so doing, the validation engine 118 may compile certain metrics for the consumer's payment account (e.g., counts and sums of spend per MCC associated with the consumer's transactions, per location, per date range, combinations thereof, etc.) at various intervals (e.g., daily, bi-weekly, weekly, monthly, per statement cycle, following each transaction to the consumer's payment account, at other regular or irregular intervals, etc.), and store the metrics in the predefined spend profile for the consumer 114 (in the data structure 120). Then in this example, when the transaction, which is the subject of the review by the consumer 114, is validated, at 310, the validation engine 118 retrieves the predefined spend profile for the consumer 114, at 314, from the data structure 120, whereby the spend profile can be consulted and/or used as described herein.

Then, regardless of whether the spend profile is compiled in real time with the request, or compiled earlier and retrieved, the validation engine 118 transmits, at 316, the spend profile to the review forum 110 (in one or more different forms as described above). In this manner, the review forum 110 is able to evaluate the review, based on the spend profile, and potentially mark the review with a symbol indicative of the spend profile of the consumer 114. For example, the review forum 110 may opt to append a “frequent diner” tag or indicator to the review from the consumer 114, because the consumer 114 transacts with merchants having the same eating place category as merchant 102 more than twice per week (or based on some other threshold related to any metric included in the spend profile). That is, the review forum 110 may receive the spend profile, where the spend profile includes the “frequent diner” tag based on evaluation by the validation engine 118. Or, the review forum 110 may rate the metrics included in the spend profile (when such metrics are included) and separately, apart from the validation engine 118 or ratings used thereby, assign the “frequent diner” tag to the consumer 114. Thus, as indicated above, the spend profile ultimately transmitted to the review forum 110 may include any desired form (e.g., a tag, particular metrics, combinations thereof, etc.).

In the above example, the review is submitted to the review forum 110. It should be appreciated, however, that the method 300 is substantially the same when the review is submitted to the merchant 102, and then the merchant 102 (or any other requestor for that matter) seeks to validate the review and/or the consumer 114.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request to validate a review from a requestor, the request including a token, the review compiled by a consumer and relating to at least one of a product and a merchant; (b) identifying a payment account based on the token, the payment account associated with the consumer; (c) compiling a spend profile for the consumer, based on a transaction history associated with the identified payment account; and (d) transmitting the spend profile, in response to the request, thereby permitting said requestor to associate the spend profile with the review and to evaluate the review based on the spend profile.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” “associated with,” or “in communication with” another feature, element or layer, it may be directly on, engaged, connected, coupled, associated, or in communication with/to the other feature, element or layer, or intervening features, elements or layers may be present. In contrast, when feature, element or layer is referred to as being “directly on,” “directly engaged to,” “directly connected to,” “directly coupled to,” “directly associated with,” or “directly in communication with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a spend profile for a consumer in response to a request for validation of a review submitted by the consumer, the method comprising:
receiving, at a computing device, a request to validate a review from a requestor, the request including a token, the review compiled by a consumer and relating to at least one of a product and a merchant;
identifying a payment account based on the token, the payment account associated with the consumer;
compiling, by the computing device, a spend profile for the consumer, based on a transaction history associated with the identified payment account; and
transmitting, by the computing device, the spend profile to the requestor, in response to the request, thereby permitting said requestor to associate the spend profile with the review and to evaluate the review based on the spend profile.

2. The computer-implemented method of claim 1, wherein the review is related to the merchant, the merchant included in a category; and
further comprising filtering the transaction history based on the category, such that filtered transactions in the transaction history involve at least one merchant within the category.

3. The computer-implemented method of claim 2, wherein the category is defined by a merchant category code (MCC); and
wherein the spend profile includes a frequency of transactions within the MCC for a defined interval.

4. The computer-implemented method of claim 1, wherein the review is related to the merchant; and
further comprising:
prior to compiling the spend profile, searching in the transaction history for at least one transaction in which the merchant is involved; and
transmitting a validation fail message when at least one transaction is not found.

5. The computer-implemented method of claim 1, wherein the review is related to the merchant; and
wherein compiling the spend profile includes compiling the spend profile from the transaction history for a defined interval, based on a merchant category code (MCC) associated with the merchant.

6. The computer-implemented method of claim 5, wherein the spend profile includes at least one of: a total spend in the MCC, a number of transactions within the MCC, and a number of distinct merchants within the MCC.

7. The computer-implemented method of claim 1, wherein the spend profile includes a rating for the consumer for a category associated with the at least one of the product and the merchant.

8. The computer-implemented method of claim 7, wherein the category includes an MCC related to restaurants and/or eating places.

9. The computer-implemented method of claim 1, further comprising issuing, by the computing device, the token to the consumer.

10. The computer-implemented method of claim 1, wherein compiling a spend profile for the consumer, based on a transaction history associated with the identified payment account, includes compiling the spend profile in response to the request.

11. A system for providing spend profiles for consumers in response to requests for validation of reviews submitted by the consumers, the system comprising:
a memory configured to store transactions, each transaction associated with one of a plurality of payment accounts; and
a processor coupled to the memory, the processor configured to:
compile a spend profile for a consumer based on at least one of the multiple transactions to one of the plurality of payment accounts associated with the consumer, said at least one of the multiple transactions being identified to a category; and
transmit the spend profile to a requestor in response to a request to validate a review for a merchant, the merchant being within the category.

12. The system of claim 11, wherein the request to validate the review includes a token and a merchant category code (MCC) indicative of the category; and
wherein the processor is configured to identify the one of the plurality of payment accounts as associated with the consumer in the memory based on the token, and to compile the spend profile based on the MCC.

13. The system of claim 12, wherein the spend profile includes a rating indicative of experience for the consumer associated with the one of the plurality of payment accounts.

14. The system of claim 11, wherein the processor is further configured to generate a token for the consumer associated with the one of the plurality of payment accounts, in response to registration of the consumer; and
wherein the processor is configured to identify the one of the plurality of payment accounts based on the token when included in the request.

15. The system of claim 11, wherein the processor is configured to validate the at least one of the multiple transactions associated with the review, based on the request to validate the review, prior to compiling the spend profile.

16. The system of claim 11, wherein the category is defined by a merchant category code (MCC); and
wherein the spend profile includes at least one of: a total spend within the MCC, a number of transactions within the MCC, and a number of distinct merchants within the MCC.

17. The system of claim 11, wherein the processor is further configured to store the spend profile in the memory and to retrieve the spend profile in response to the request to validate the review.

18. A non-transitory computer-readable storage media including computer-executable instructions for providing spend profiles for consumers in response to requests for validation of reviews submitted by the consumers, which, when executed by a processor, cause the processor to:
generate a token for a consumer and associate the token with a payment account of the consumer, in response to registration of the consumer;
receive a request to validate a review from a requestor, the review compiled by the consumer and relating to at least one of a product and a merchant, and the request including the token for the consumer;
identify the payment account of the consumer in a data structure based on the token;
compile a spend profile for a consumer based on at least one transaction to the payment account, the at least one transaction being identified to a category of the product and/or the merchant; and
transmit the spend profile to the requestor, in response to the request, thereby permitting said requestor to associate the spend profile with the review and to evaluate the review based on the spend profile.

19. The non-transitory computer-readable storage media of claim 18, wherein the computer-executable instructions, when executed by the processor, further cause the processor, in connection with compiling the spend profile for the consumer, to compile the spend profile in response to the request to validate the review.

20. The non-transitory computer-readable storage media of claim 18, wherein the computer-executable instructions, when executed by the processor, further cause the processor to store the spend profile in the data structure and retrieve the spend profile from the data structure in response to the request to validate the review.
